(19) United States
(12) Patent Application Publication
(10) Pub. No.: US 2005/0271767 A1
(43) Pub. Date: Dec. 8, 2005

(54) Injection moulding device

(76) Inventor: Ralph Kruidering, Cromvoirt (NL)

Correspondence Address: Norman H Zivin;Cooper & Dunham, 1185 Avenue of the Americas, New York, NY, 10036, US

(21) Appl. No.: 10/520,830

(22) PCT Filed: Feb. 6, 2003
(86) PCT No.: PCT/NL03/00081

§ 371 Date: Jul. 14, 2005

(30) Foreign Application Priority Data
Jul. 12, 2002 (NL) 1021064

(51) Int. Cl. B29C 45/66

(52) U.S. Cl. 425/589

(57) ABSTRACT

Injection moulding device (1) consisting of two mould sections which (33, 34) can move with respect to one another and between which a mould cavity (36) is delimited. The movable mould section (33) is joined via an articulated joint (15) to the operating means (5-14) therefor which execute the closing movement. Centring means (25, 30) are present to centre the movable mould section (33) with respect to the stationary mould section when (34) the moulds close. An injection moulding device can optionally be equipped for compression-injection moulding of plastic. The operating means (5-14) can be constructed with the aid of a crank shaft/connecting rod (5, 6) construction.

The present invention relates to an injection mould device according to the preamble of claim 1. Such an injection mould device is known from U.S. Pat. No. 5,556,656 and comprises a heavy frame, that generally extends horizontal, to one side of which the fixed mould section is joined, which in general is also provided with the plastic feed. The movable mould section is mounted via a particularly heavy construction such that it is able to slide with respect to the frame. Such a construction must be relatively heavy because no significant movement between the mould sections may take place even under the high closing forces that are required when injecting. Because increasingly more stringent requirements are imposed on the accuracy of the injection, increasingly more stringent requirements are imposed on the rigidity of the construction. As a result the costs of the injection moulding devices are increasing more and more. Moreover, in view of the construction of conventional injection moulding devices it is generally customary to set these up horizontally, as a result of which they take up a relatively large amount of space.

U.S. Pat. No. 5,556,656 discloses a horizontal moulding machine wherein the direction of closing is in horizontal direction. The movable die is pivotably connected to the ram. A guiding is provided to guide the movable die to and fro relative to the stationary die.

U.S. Pat. No. 4,682,940 discloses a vulcanising press wherein the die parts are moved in vertical direction relative to each other.

The aim of the present invention is to provide an injection moulding device that can be of more lightweight, more compact construction and can be produced less expensively, it nevertheless being ensured that the particularly stringent tolerances imposed on injection moulding are met. This applies, for example, for injection moulding DVDs, where particularly stringent requirements are imposed with respect to the mutual position of the mould sections.

This aim is achieved with an injection moulding device as above having the characterising features of claim 1.

According to the invention there is no longer a rigid joint between the movable mould section and the operating means therefor. Moreover, centring means are provided for centring the movable mould section with respect to the stationary mould section. As a result it is no longer necessary to make the frame of the injection moulding device and the construction of the operating means such that they have flexural stiffness. After all, the (slight) deformation that occurs when the mould is closed can be taken up by the non-rigid joint between the operating means and the movable mould section when the movable mould section and the stationary mould section become centred with respect to one another.

As a result the frame and associated structural parts can be of appreciably simpler construction. The costs will decrease as a result. Moreover, it is now possible in a simple manner to allow the device to operate vertically, that is to say to construct it with a vertical closing movement of the movable mould section. In certain cases this has advantages when changing mould sections for injecting other products (centring with respect to the seating therefor) and when removing products after injection.

The non-rigid joint between the operating means and the movable mould section can comprise any joint known in the art. This joint has to be rigid only in the direction of closing. A spherical bearing is mentioned by way of example. Optionally this can be constructed as an assembly with a ball both close to the mould section and to the operating means, a dual cup being placed between them. In this way a dual pivot bearing is formed that allows tilting and slight movement in the horizontal plane (in the case of a vertical closing movement) of the movable mould section with negligible friction.

According to the invention a number of columns extend in the direction of movement. These columns are arranged between the operating means and the movable part. The columns are rigid (to pressure) in the longitudinal direction, that is to say in the direction of movement, and weak in the transverse direction. The weakness can be achieved by making recesses, such as grooves, in the columns. By fitting a number of columns next to one another parallel with respect to one another, mutual movement of the bottom joint face with respect to the top joint face is possible but, because of the presence of the columns, this movement is purely parallel, that is to say a sort of parallelogram construction is obtained. It has been found that if a larger number of columns is used the total “weakness” of the construction, that is to say the mobility in the direction perpendicular to the direction of movement, can be greater. A practical number is four, but any other number can be used.

Another possibility for producing a joint between the operating means and the movable part consists in fitting two discs. These discs are spaced from each other and are each in a plane perpendicular to the direction of movement. The discs are joined to one another by a rib. If the discs are circular, this rib is preferably a radial rib. As a result a tilting movement about said rib is possible. With this arrangement the rib is preferably of straight construction.

Combination of the joints described above is possible.

The same applies in respect of the centring means. These can comprise any construction known in the state of the art, such as a pin/hole connection. According to an advantageous embodiment of the invention, a ridge/recess construction is used. Of course, either the free ends of the ridges or the first part of the recesses or both are constructed to be self-seeking to some extent. Such ridges/recesses, of which at least three are present, ensure complete locking in the horizontal plane (with a vertical closing direction). It has been found that with such a construction the slight deviations that arise when using a “weak” frame can be taken up without any problem in combination with the non-rigid joint between the operating means and the mould section.

According to a further advantageous embodiment the centring means consist of interacting rollers/recesses. Preferably, there are recesses both in the top part and the bottom part of the mould and rollers are placed in the bottom part. These provide for a centring action by the top part when the mould parts move towards one another. The recess is preferably made in the form of a radial groove.

The operating means can be any construction known in the art, such as a ram. This can be operated hydraulically, electromechanically or pneumatically. According to an advantageous embodiment of the invention the operating means are constructed as a crankshaft/connecting rod system. The free end of the connecting rod is provided with auxiliary rods, one end of which engages on a piston guided in a cylinder, which piston is joined in a non-rigid manner to the movable mould section, whilst the other auxiliary rod is connected to the frame. This connection to the frame can optionally have various positions, as a result of which the opening stroke of the injection moulding device can be adjusted. Thus, it is possible to provide a first opening position for removing articles and a second, further opened position in which the mould sections or stamper can be changed or maintenance can be carried out.

Through a crankshaft/connecting rod mechanism it is possible to obtain a non-linear movement pattern for the movable mould half, as a result of which a high closing force, which is very accurately determined, can be achieved for the mould section with a relatively low power at the crankshaft. This closing force can be pressure-controlled, position-controlled, path controlled etc.

According to a preferred embodiment of the invention venting of the cavity is possible.

This can be achieved with an annular part that delimits the mould cavity. A separate annular part can be used for this purpose, but according to an advantageous embodiment of the invention for this purpose the annular part is constructed as a sleeve, which sleeve simultaneously serves as vent ring.

According to a further advantageous embodiment of the invention, at least one of the mould sections is provided with cooling and/or heating channels to control the injection moulding process and the subsequent cooling as accurately as possible and optionally to shorten the cycle time.

According to an advantageous embodiment of the invention at least one of the mould sections is so constructed that compression-injection moulding (praegen) is possible. That is to say, the periphery of the mould cavity is closed during a first part of the closing movement and as the closing movement is continued the distance between the mould sections facing one another is reduced to some extent, as a result of which compression-injection moulding of the plastic already injected takes place. The various operations can take place as fresh plastic is injected or when the injection of plastic has been completed.

A stepped closing movement of this type can be combined with the centring described above and the movable joint between operating means and movable part. During the first phase of positioning with respect to one another, a reaction will occur between the operating means and the movable part. When the sections of the mould facing one another come into contact further displacement is impossible, but further centring can be provided by means of the mutual movement.

The invention will be described in more detail below with reference to an illustrative embodiment of the invention shown in the drawing. In the drawing:

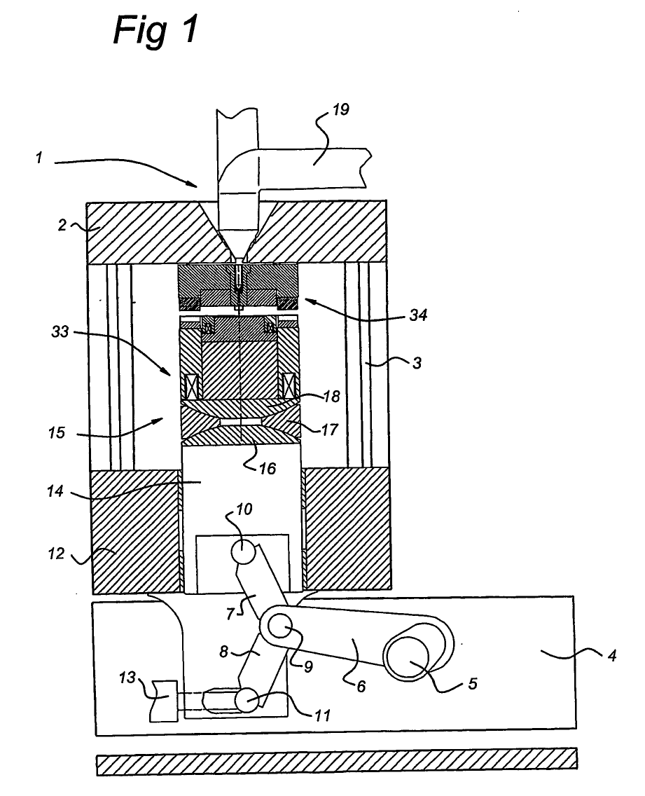

FIG. 1 shows, diagrammatically, a cross-section of the injection moulding device according to the present invention with the operating means in the position for injection;

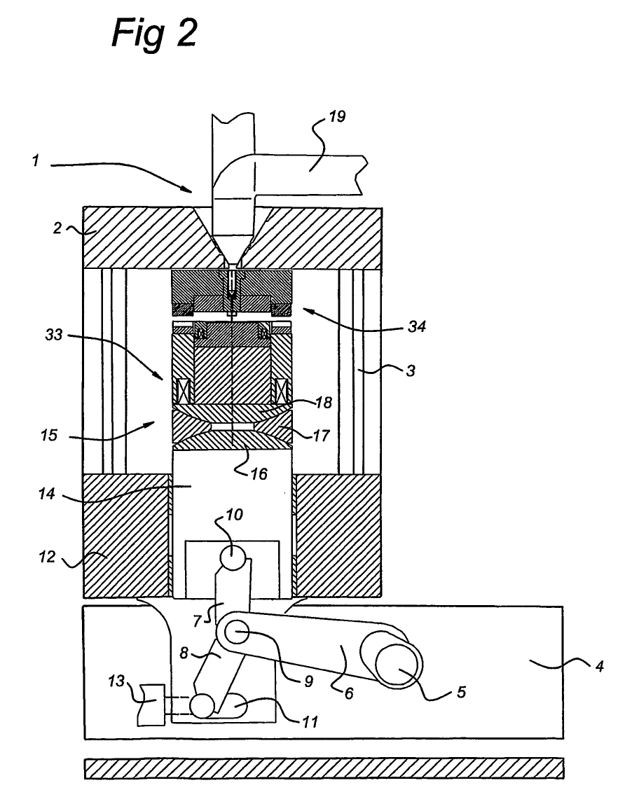

FIG. 2 shows the injection moulding device according to FIG. 1 with operating means in the position for maintenance;

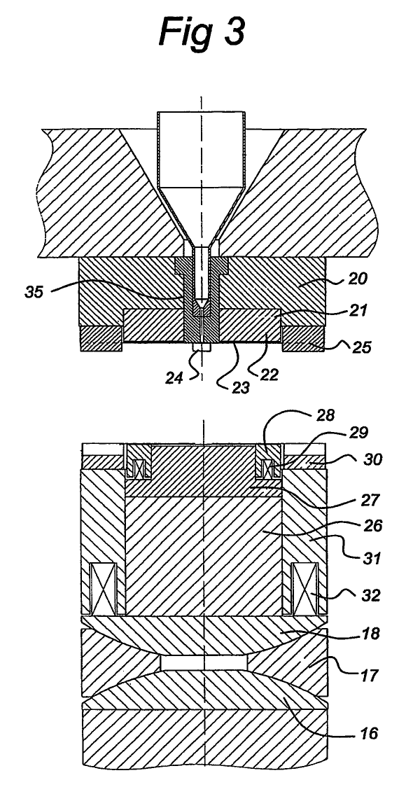

FIG. 3 shows, in section, a detail of the injection moulding device according to FIGS. 1 and 2;

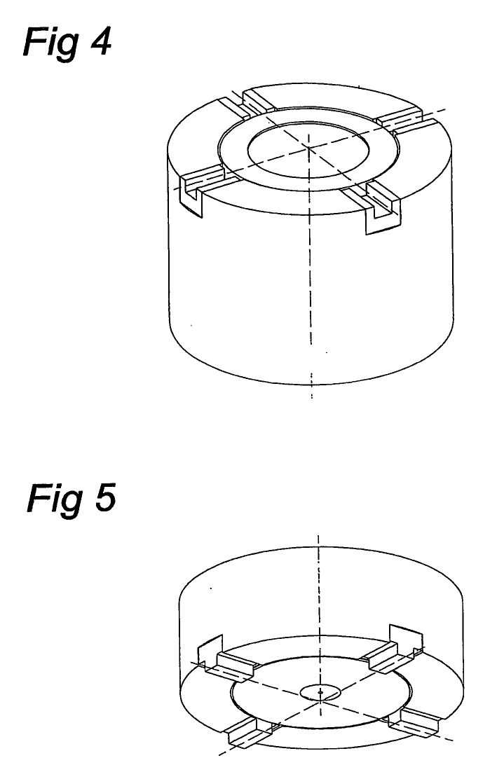

FIG. 4 shows a perspective view of the centring means of the bottom mould section;

FIG. 5 shows a perspective view of the centring means of the top mould section;

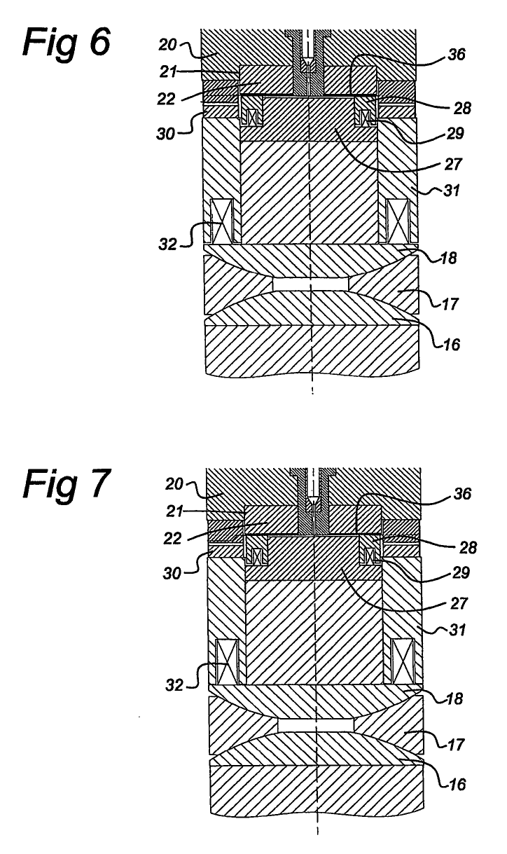

FIG. 6 shows, in cross-section, the first phase of closing the mould cavity,

FIG. 7 shows a further phase of closing a mould cavity,

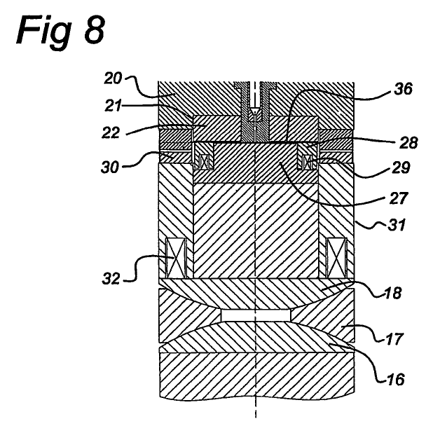

FIG. 8 shows the final phase of closing the mould cavity of the mould sections for the device according to the invention;

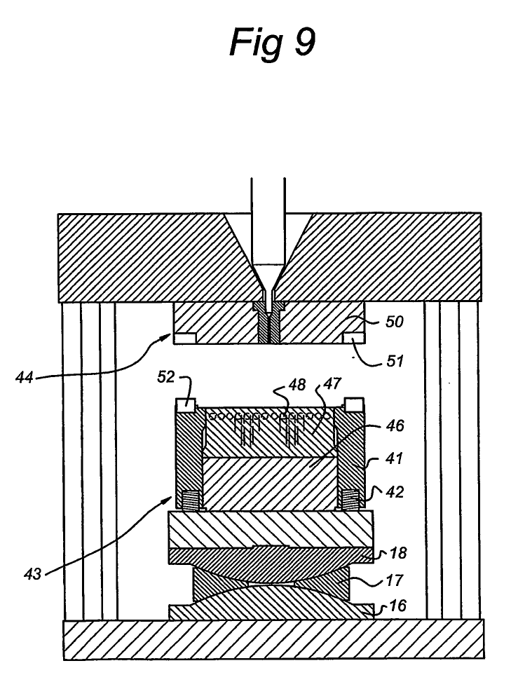

FIG. 9 shows, diagrammatically in cross-section, part of the construction shown in FIG. 1 in an alternative embodiment;

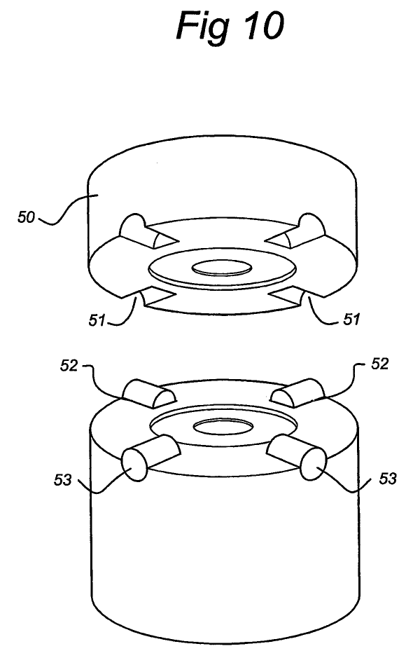

FIG. 10 shows a partially exposed perspective view of the centring means according to the variant in FIG. 9; and

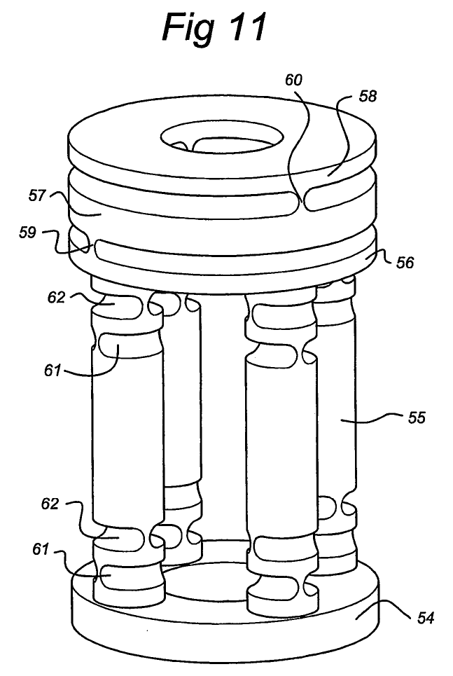

FIG. 11 shows, in perspective, a further embodiment of the joint between operating means and movable part.

In the figures, and in particular FIGS. 1 and 2, the injection moulding device according to the invention is indicated in its entirety by 1. This device consists of a top frame 2 that is connected to the baseplate 4 in a relatively “weak” manner by means of, for example, three or four columns. In the construction shown here the injection moulding device is set up vertically, that is to say the mould sections move in the vertical direction with respect to one another.

The operating means for the movable mould section comprise a crankshaft 5 which is driven in some way or other by means of a motor and control which are not shown in more detail. The crank of crankshaft 5 is joined to a connecting rod 6, which is provided close to the free end with a pivot joint 9 to which auxiliary rods 7 and 8 are fixed such that they pivot. Auxiliary rod 7 engages pivot joint 10 of piston 14, whilst auxiliary rod 8 engages on pivot joint 11 on the end of the plunger rod of ram 13. This plunger rod can assume two positions, as can be seen by comparing FIGS. 1 and 2. The position of piston 14 of course changes as a result. In the position of the plunger rod of ram 13 shown in FIG. 1, complete closure of the mould cavity can be obtained by moving crankshaft 5, that is to say the mould sections can move fully towards one another. In the position shown in FIG. 2 this is not possible, but further opening of the mould sections facing one another takes place, as a result of which access to the parts concerned is simplified.

A dual pivot bearing indicated by 15 is located on the piston 14. This bearing consists of a bearing ball indicated by 16, onto which a bearing ring 17 is fitted that is cup-shaped on either side. One side engages on the bearing ball 16 and the other side engages on a bearing ball 18 that bears on the movable mould section 33. The stationary mould section is indicated by 34 and has a top plate 20 and a plastic feed 19.

With the dual pivot bearing 15 the movable mould section can be moved in the horizontal plane to some extent with respect to piston 14 on which it rests and is also able to tilt.

Further details of the mould sections are shown in FIGS. 3-5. It can be seen from these figures that top plate 20 is provided with a seat 21 for accepting a so-called mirror 22. The relevant illustrative embodiment shown here relates to the production of an information carrier in disc form and for this purpose a so-called stamper or negative 23 is mounted on mirror 22. The sprue nozzle is indicated by 35.

Mould section 34 is furthermore provided with four centring ridges 25. Details of these can be seen in FIG. 5.

The movable mould section 33 is provided with centring grooves 30 interacting therewith. Details of these can be seen in FIG. 4. These grooves are located on a sleeve 31 which, with a number of springs 32, bears on bearing ball 18. The base body 26 bears directly on the bearing ball 18. A mirror 27 is supported on this base body 26. There is a vent ring 28, which has been pretensioned with the aid of springs 29.

With the aid of the construction shown here of centring ridges 25/centring grooves 30 on the one hand and the pivot bearing 15 on the other hand it is possible that piston 14 is not precisely aligned with mould section 34. After all, this non-alignment of piston 14 translates into non-alignment of mould section 33, but, as a result of the presence of the centring means and the pivot bearing, a centring movement will be carried out during closing, as a result of which the mirrors 22 and 27 reach precisely the desired position. By making the centring grooves/centring ridges radial, positioning in the horizontal plane is guaranteed with particularly high accuracy.

The closing movement of the injection moulding device according to the present invention will be explained with reference to FIGS. 6-8. FIG. 6 shows the state in which the sleeve 31 is in contact with the top mould section. In this state the vent ring 28 is not yet in contact with the corresponding part of the mirror 22 or the stamper 23. As the pressure builds up further the dual pivot bearing comes into play and mirrors 22 and 27 become precisely parallel. On further movement the vent ring 28 comes into contact with part 22 (FIG. 7). At that point in time a closed mould cavity, which is indicated by 36, is delimited. Plastic can be injected at that point in time. After or during the injection of plastic, a further closing movement is generated with the aid of the operating means, that is to say by further rotation of crankshaft 5. During this movement the base body, and thus the mirror 27, moves further upwards and the position of the ring 31 and vent ring 28 is stationary through compression of springs 32. The plastic is compacted as a result. Further compaction into the final position takes place by continuation of the movement, the state as shown in FIG. 8 being produced. In this state the bottom end of sleeve 31 is in contact with ball part 18. The “play” of the vent ring 28 is such that the bottom thereof is not in contact with mirror 27. In this way compression-injection moulding of the plastic can be obtained, by which means, for example for impressing information on information carriers, a more accurate product can be obtained.

A variant of the pivot construction is shown in FIG. 11. This construction consists of a plate 54 that is joined, in a manner not shown in more detail, to piston 14 (FIG. 1). Plate 58 serves as support for springs 42 (FIG. 9) and base body 46.

A number (four in this case) of compression-resistant columns 55 are fitted on plate 54. These columns are provided with recesses 61, 62 which always extend in perpendicular directions. As a result each of these columns is relatively weak in the transverse direction (of the drawing). At the other end these columns are joined to plate 56. With this construction high compressive forces can be transferred from plate 54 to plate 56. Moreover, plate 56 is able to move laterally (in the drawing) with respect to plate 54, but will always maintain the same orientation during this movement. That is to say, if plates 54 and 56 are originally parallel, these will remain parallel during lateral movement. By using a large number of columns 55 a relatively weak construction can be provided with which it is possible to provide for adjustments in tenths of mm.

If there is incorrect alignment with respect to the angular position, a plate 57 can be fitted between plates 56 and 58. This plate 57 is always some distance away from plate 56 and from plate 58 and is joined thereto by means of a rib 59 and 60, respectively, extending radially. By arranging these ribs perpendicular to one another, a tilting movement in two perpendicular directions (X-Y) is possible. It will be understood that the alternative described above for a pivot bearing can be used in combination with the pivot bearing or instead of this. Moreover, it is possible to use only the columns and/or only the plates 56, 57, 58 that are able to tilt with respect to one another.

FIGS. 9 and 10 show a variant of the construction described above and more particularly a detail close to the mould sections which are indicated by 43 and 44. The vent ring indicated by 28 in the previous figures is combined with the sleeve indicated in the previous figures and is now indicated by 41. This sleeve 41 is under the influence of the pressure from springs 42. The construction with the bearing cup, bearing ring and further bearing cup essentially corresponds to that which has been described above. The base body is indicated by 46 here. The mirror 47 resting on said base body is provided with heating or cooling channels, indicated by 48, by means of which the temperature can be influenced in an optimum manner during injection moulding.

In contrast to the construction shown previously with reference to FIGS. 4 and 5, centring no longer takes place with centring ridges but with the aid of centring rollers. The various features are illustrated with reference to FIG. 10. Top plate 50 is provided with a number of radial grooves 51. Corresponding radial grooves 52 have been made in sleeve 41. A number of rollers 53 are placed in an annular groove 52 and effect the centring movement while the mould sections 43 and 44 move towards one another.

In principle it is possible to make the construction shown with reference to FIGS. 9 and 10 without the presence of the pivot construction 16-18. It must be understood that this compression-injection moulding is merely optional. And, moreover, it must be understood that the invention is not restricted to the injection moulding of the product described above.

Variants of the device described above will be immediately apparent to those skilled in the art on reading the above description and fall within the scope of the appended claims.

1-17. (canceled)

18. Injection moulding device comprising two parts that can move with respect to one another for delimiting a mould cavity between them, wherein at least one of said parts is provided with a plastic feed that can be shut off, at least one of said parts, the stationary part, is joined to a frame and the other, movable part can be moved with respect to said frame by means of operating means, the joint between said movable part and said operating means allowing movement of said movable part with respect to said operating means in a direction that is not the direction of movement of the operating means, wherein said parts move in vertical direction with respect to one another, said joint between said movable part and said operation means is embodied to allow tilting and slight movement in the horizontal plane and in that centring means are fitted for centring the movable part with respect to the stationary part when the stationary part and the movable part move towards one another, wherein said joint comprises a number of columns which extend in the direction of movement next to one another parallel with respect to one another and are arranged between the operating means and said movable part, which columns are rigid in the longitudinal direction thereof and are weak in the transverse direction thereof.

19. Injection moulding device according to claim 18, wherein said joint comprises a ball/cup assembly, the axis of which essentially corresponds to the direction of movement of the movable part.

20. Injection moulding device according to claim 18, wherein said joint comprises two discs located some distance apart one after the another in the direction of movement, joined by a rib extending essentially perpendicularly to said direction of movement.

21. Injection moulding device according to claim 19, wherein said discs located some distance apart are fitted adjoining said movable part.

22. Injection moulding device according to claim 18, wherein said centring means comprise interacting centring ridges/centring recesses, either said centring ridges or said centring recesses being arranged on the boundary surface of the stationary part, or said centring recesses or said centring ridges being arranged on the boundary surface of the movable part.

23. Injection moulding device according to claim 22, comprising centring ridges/centring recesses that are radial with respect to the closing movement.

24. Injection moulding device according to claim 18, wherein said centring means comprise interacting centring rollers/centring recesses, said centring recesses being made in both the stationary part and the movable part and said rollers being accommodated in said centring recesses.

25. Injection moulding device according to claim 24, wherein said centring recesses comprise annular grooves.

26. Injection moulding device according to claim 18, wherein said operating means comprise an element engaging the movable part, provided with a ball-like surface engaging in a cup of a ring that is cup-shaped on either side, the movable part being provided with a cup-shaped part engaging in the other cup of said ring.

27. Injection moulding device according to claim 18, wherein said operating means comprise an element engaging the movable part that is guided as piston in a cylinder joined to said frame.

28. Injection moulding device according to claim 18, wherein said operating means comprise a crankshaft/connecting rod mechanism.

29. Injection moulding device according to claim 18, wherein said operating means are designed to provide a first opening position for removing said injected articles and a second, further opened position for maintenance and/or changing mould sections.

30. Injection moulding device according to claim 18, wherein the mould cavity is provided around the periphery, that is to say in a direction parallel to the closing movement of said parts, with a closing ring which, under spring pressure, can move with respect to the part around which it is fitted, such that after said closing ring has engaged on the opposite part said parts are able to centre with respect to one another.

31. Injection moulding device according to claim 30, wherein said closing ring is constructed as a venting ring.

32. Injection moulding device according to claim 18, wherein at least one of said movable parts is provided with cooling/heating channels.

33. Injection moulding device according to claim 18, designed for the injection of one or more disc-shaped information carriers.
